(19) United States
(12) Patent Application Publication
(10) Pub. No.: US 2019/0120435 A1
(43) Pub. Date: Apr. 25, 2019

(54) PRESSURE TANK ARRANGEMENT FOR STORING AND DISCHARGING COMPRESSED LIQUID FUELS

(71) Applicant: REHAU AG + CO, Rehau (DE)

(72) Inventors: Thomas LANZL, Marktredwitz (DE); Franz HOFMANN, Münchberg (DE); Andreas GRUHL, Dresden (DE)

(21) Appl. No.: 15/743,194

(22) PCT Filed: Jul. 11, 2016
(86) PCT No.: PCT/EP2016/001188

§ 371 Date: Jan. 9, 2018

(30) Foreign Application Priority Data
Jul. 10, 2015 (DE) 20 2015 005 025.5

(51) Int. Cl. F17C 13/08; F17C 1/06

(52) U.S. Cl. CPC F17C 13/084; F17C 1/06; F17C 2201/0109; F17C 2201/035; F17C 2203/012; F17C 2203/0614; F17C 2270/0168; F17C 2203/0663; F17C 2205/018; F17C 2205/0192; F17C 2221/012; F17C 2221/033; F17C 2203/066

(57) ABSTRACT

The present invention relates to a pressure tank arrangement for storing and discharging compressed liquid fuels and to a method for producing a pressure tank arrangement of this type. Here, force transmission elements of the pressure tank arrangement are arranged in such a way that they utilize the available installation space for pressure tank arrangements of this type in an optimum manner.

### CROSS-REFERENCE TO RELATED APPLICATIONS

This application is a National Stage of International Application No. PCT/EP2016/001188, filed on Jul. 11, 2016, and published in German as WO2017/008899 A1 on Jan. 19, 2017. This application claims the priority to German Patent Application No. 20 2015 005 025.5, filed on Jul. 10, 2015. The entire disclosures of the above applications are incorporated herein by reference.

### FIELD

The disclosure relates to a pressure tank arrangement for storing and discharging compressed fluidic fuels. Pressure tank arrangements comprising a pressure vessel which defines an inner space in which the fuel can be stored, wherein the longitudinal dimension of the pressure vessel is greater than its transverse dimension, a preferably elongated central portion and at least one end cap adjacent to the center portion, wherein the end cap tapers toward an end region, and comprising a preferably braided and/or wrapped reinforcing layer that envelops the central portion and the end cap of the pressure vessel, wherein the reinforcing layer comprises at least two superposed fiber-reinforced individual layers, and comprising at least one force application element which comprises a connecting portion and an anchoring portion, are known from the prior art. The force application elements are in this case connected to the valve of the pressure tank arrangement, via which the fluidic fuel (e.g. hydrogen, or liquid gas) can be discharged. In this context, one speaks of a so-called “neck-mounting”.

### BACKGROUND

This section provides background information related to the present disclosure which is not necessarily prior art.

The disadvantage of such a pressure tank arrangement is that the construction length of the pressure tank is extended by the dimension of the force application element. When installing a pressure tank arrangement of the prior art in a predefined installation space (for example in a motor vehicle) the pressure tank has to be shortened correspondingly, whereby its storage capacity is reduced.

### SUMMARY

This section provides a general summary of the disclosure, and is not a comprehensive disclosure of its full scope or all of its features.

Thus, it is an object of the disclosure to provide a pressure tank arrangement comprising the features as indicated above, which compared to the prior art has a larger storage capacity.

This object is achieved according to the disclosure in that the anchoring portion is disposed between the reinforcing layer and the pressure vessel and/or between the individual layers of the reinforcing layer, and the connecting portion penetrates the reinforcing layer and is accessible from the outside of the reinforcing layer, wherein the connecting portion protrudes into the space which is enclosed by a shell surface which is obtained by an imaginary extrusion of the outer boundary line of the largest cross-sectional area of the reinforced central portion in a direction parallel to a centroidal line which is formed from the centroids of all cross-sectional areas of the pressure vessel, by a surface intersecting the end region and extending perpendicular to the centroidal line, as well as by the surface of the reinforcing layer.

The pressure tank arrangement according to the disclosure advantageously utilizes the dead space which is obtained by the cross-sectional reduction of the pressure vessel in the region of the end cap or end caps. As a result, the installation space in which the pressure tank arrangement is received in its intended use can be utilized much better and, thus, the storage volume of the pressure tank can be increased compared to conventional pressure tank arrangements.

Here, the connecting portion is preferably braided or wrapped by the fibers of the fiber-reinforced individual layers, so that the connecting portion penetrates the reinforcing layer and is or remains accessible from the outside of the reinforcing layer, wherein the anchoring portion is overbraided and/or overwrapped by at least one single layer.

Preferably, the anchoring portion is disposed between the individual layers of the last third, preferably the last quarter, particularly preferably the last sixth of all individual layers of the reinforcement layer, starting from the pressure vessel.

Preferably at least two, particularly preferably at least four force application elements are provided for the or each end cap. Advantageously, the force application elements are disposed along an imaginary circle of holes. Herein, the force application elements can have equal distances with respect to one another and/or enclose equal angles with respect to each other. For example, four force application elements can be provided, which are arranged in a uniform spacing and under an angle of 90° with respect to each other along a common circle of holes. The anchoring portion or the anchoring portions may be fixed in position on the pressure vessel or on a single layer of the reinforcing layer by means of an adhesive layer and/or by means of a fixing means.

The force application element preferably includes an external thread or an internal thread, more preferably a metric external thread or a metric internal thread. The force application element is preferably made of a stainless steel material or of an aluminum material or of a magnesium material or of a titanium material.

The force application element may be provided with a corrosion protection layer.

The anchoring portion may have a plate-like or disk-like shape.

The anchoring portion may have a shape corresponding to the adjacent outer geometry of the pressure vessel.

The reinforcing layer may comprise a thermoplastic resin and/or a thermosetting resin to stabilize the fibers of the fiber-reinforced individual layers.

The disclosure further relates to a method for producing a pressure tank arrangement described above for storing and discharging compressed fluidic fuels, comprising:
a pressure vessel (1) defining an interior space in which the fuel can be stored, wherein the longitudinal dimension (L) of the pressure vessel (1) is greater than its transverse dimension (Q), a central portion (M) and at least one end cap (P1, P2) adjacent to the central portion (M), wherein the end cap (P1, P2) is tapering towards an end region (E1, E2), and
a braided and/or wrapped reinforcing layer (A), which encloses the central portion (M) and the end cap (P1, P2) of the pressure vessel (1), wherein the reinforcing layer (A) comprises at least two superposed fiber-reinforced individual layers, and
at least one force application element (2) comprising a connecting portion (3) and an anchoring portion (4),
   wherein the anchoring portion (4) is disposed between the reinforcing layer (A) and the pressure vessel (1) and/or between the individual layers of the reinforcing layer (A), and wherein the connecting portion (3) penetrates the reinforcing layer (A) and is accessible from the outside of the reinforcing layer (A), wherein
   the connecting portion (3) protrudes into the space (R1, R2), which is enclosed by a shell surface (MF) which is obtained by an imaginary extrusion of the outer boundary line (BL) of the largest cross-sectional area of the reinforced central portion (M) in the direction parallel to a centroidal line (S) formed of the centroids (FS) of all cross-sectional areas of the pressure vessel (1), by a surface (EF1, EF2) intersecting the end region (E1, E2) and extending perpendicular to the centroidal line (S), as well as by the surface (OF) of the reinforcing layer (A).

The anchoring portion can be overbraided and/or overwrapped by at least one single layer, wherein at the same time the connecting portion is braided and/or wrapped, so that the connecting portion penetrates the reinforcing layer and is accessible or remains accessible from the outside of the reinforcing layer.

The connecting portion may for this purpose comprise a tapered geometry which is integrally formed with or detachably connected to the connecting portion, in particular a conical, a cone-shaped or a pyramidal tip, so that the fibers of the fiber-reinforced individual layers are deflected around the connecting portion during the braiding and/or wrapping of the anchoring portion. As a result, the connecting portion is not overbraided or overwrapped.

The reinforcing layer can pressure infiltrated with a thermoplastic resin and/or a thermosetting resin. Particularly preferably, the force application element or the force application elements can be positioned relative to each other during the pressure infiltration process by means of a positioning device connected to, preferably releasably connected to the connecting portion or the connecting portions.

Further areas of applicability will become apparent from the description provided herein. The description and specific examples in this summary are intended for purposes of illustration only and are not intended to limit the scope of the present disclosure.

### EXEMPLARY EMBODIMENTS

### Drawings

The drawings described herein are for illustrative purposes only of selected embodiments and not all possible implementations, and are not intended to limit the scope of the present disclosure.

In the following the disclosure will be explained with reference to the drawings which merely show exemplary embodiments. The drawings schematically show:

FIG. 1 shows a side view of a first pressure tank arrangement;

FIG. 2 shows a front view of the first pressure tank arrangement of FIG. 1;

FIG. 3 shows a side view of a further pressure tank arrangement;

FIG. 4 shows a front view of the further pressure tank arrangement of FIG. 3; and

FIGS. 5a-c show different views of the force application element.

Corresponding reference numerals indicate corresponding parts throughout the several views of the drawings.

### DETAILED DESCRIPTION

Example embodiments will now be described more fully with reference to the accompanying drawings.

In the figures, identical or functionally identical elements are provided with the same reference numerals.

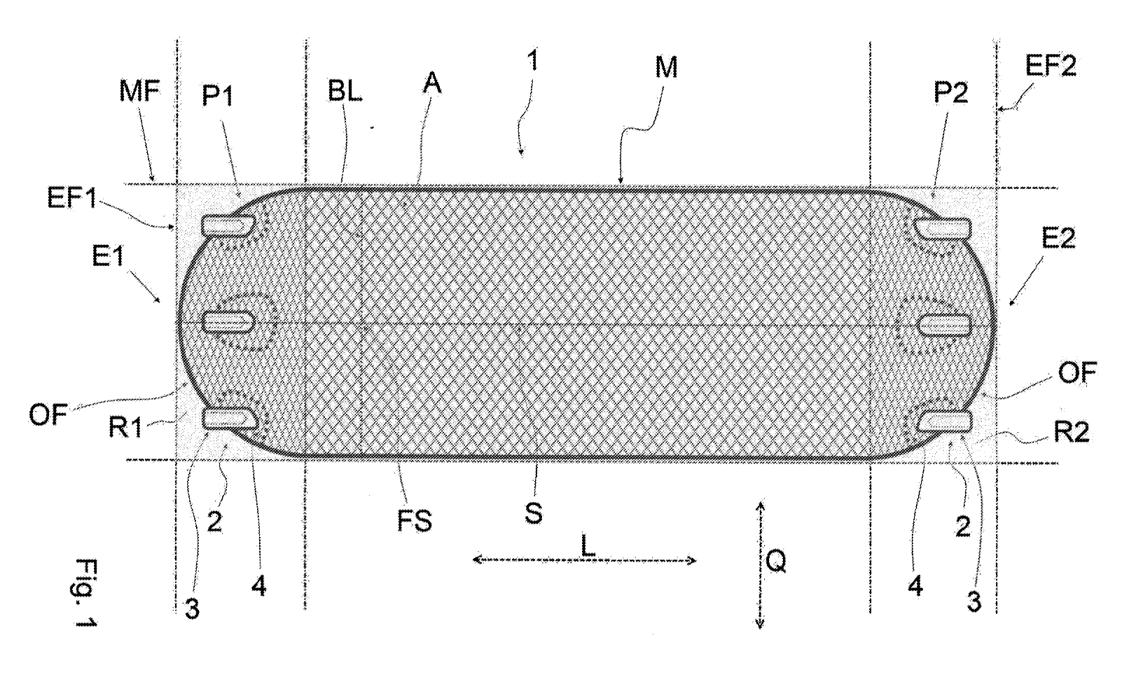

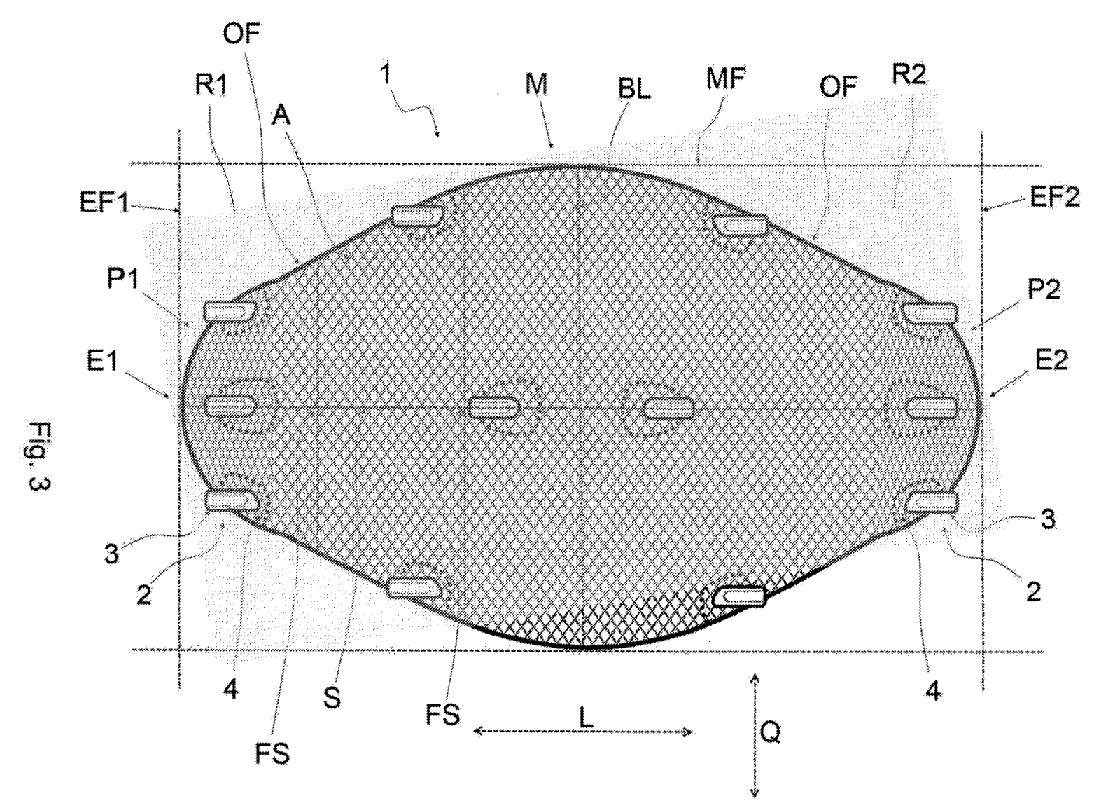

FIGS. 1 and 3 show a pressure tank arrangement for storing and discharging compressed fluidic fuels comprising a pressure vessel 1 which defines an inner space in which the fuel can be stored, wherein the longitudinal dimension L of the pressure vessel 1 is greater than its transverse dimension Q, a middle portion M and at least one end cap P1, P2 adjacent to the central portion M, wherein the end cap P1, P2 tapers toward an end region E1, E2. A preferably braided and/or wrapped reinforcing layer A encloses the central portion M and the end cap P1, P2 of the pressure vessel 1, wherein the reinforcing layer A comprises at least two superposed fiber-reinforced individual layers. The pressure tank arrangement further comprises at least one force application element 2 which comprises a connecting portion 3 and an anchoring portion 4. The anchoring portion 4 is arranged between the reinforcing layer A and the pressure vessel 1 and/or between the individual layers of the reinforcing layer A, and the connecting portion 3 penetrates the reinforcing layer A and is accessible from the outside of the reinforcing layer A. The connecting portion 3 protrudes into the space R1, R2 which is enclosed by a shell surface MF which is obtained by an imaginary extrusion of the outer boundary line BL of the largest cross-sectional area of the reinforced central portion M (that is, of the pressure vessel plus the reinforcing layer thickness in the area of the central portion) in the direction parallel to a centroidal line S which is formed of the centroid points FS of all cross-sectional areas of the pressure vessel 1, by a surface EF1, EF2 intersecting the end region E1, E2 and extending perpendicular to the centroidal line S, and by the surface OF of the reinforcing layer A. The pressure tank arrangement FIG. 3 differs from the pressure tank arrangement according to FIG. 1 by a crowning of the pressure vessel.

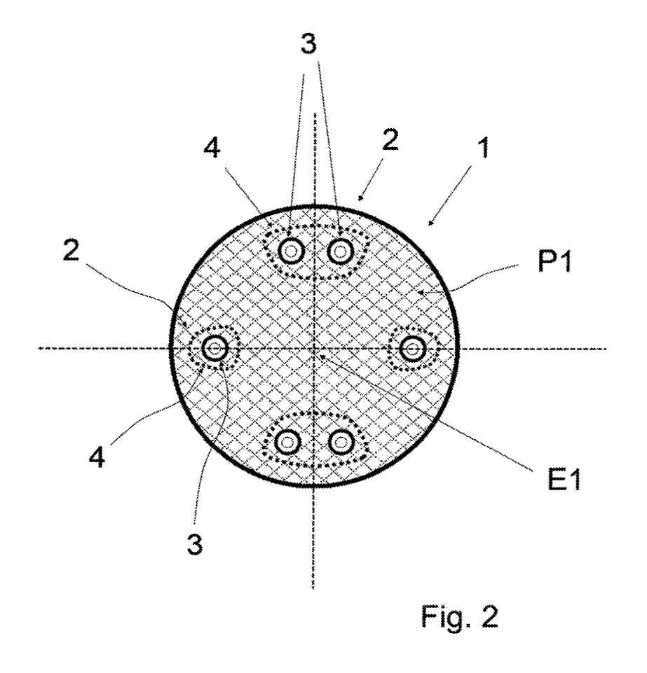

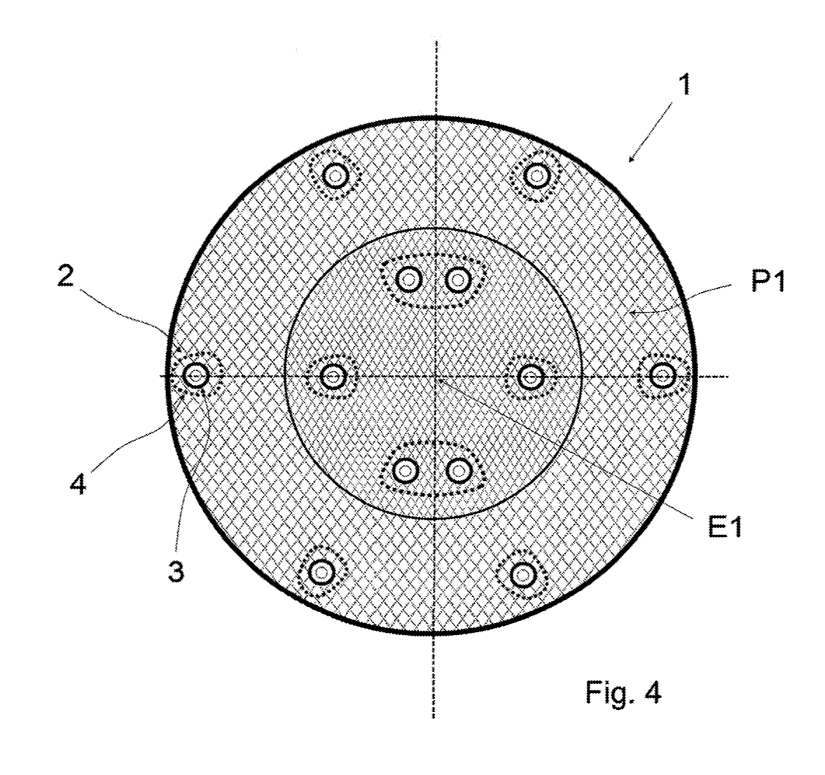

FIGS. 2 and 4 respectively show the front views of the pressure tank arrangements according to FIG. 1 or FIG. 3. Here, it is apparent that a force application element 2 may comprise a plurality of connecting portions 3 or that two force application elements 2 may share a common anchoring portion 4.

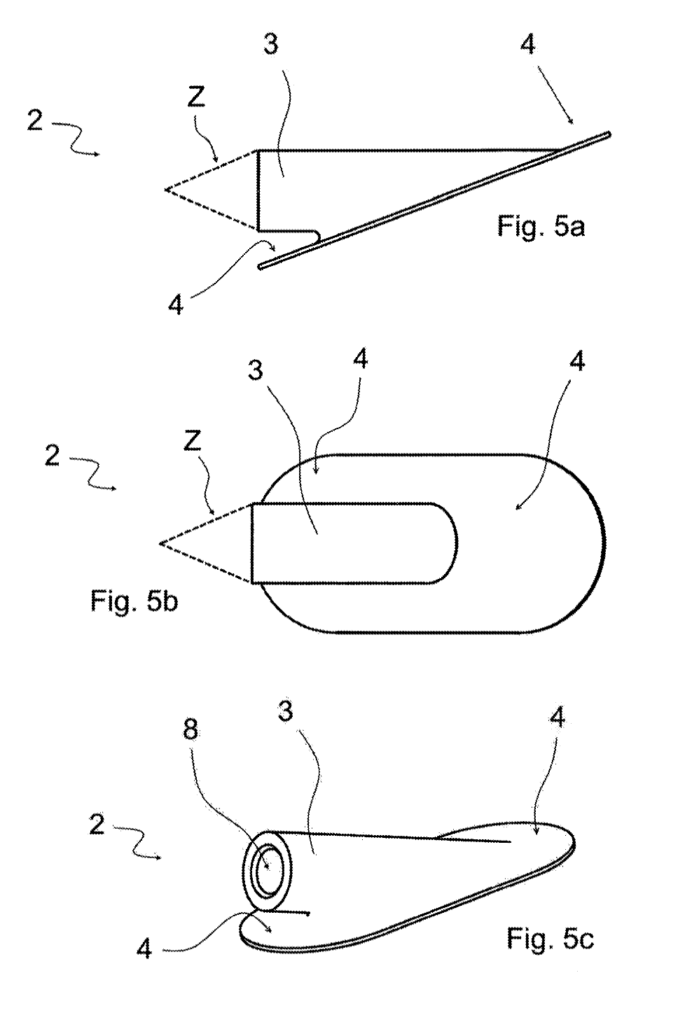

FIGS. 5a to 5c show a force application element 2 in different views. The force application element 2 may be made of a stainless steel material. The anchoring portion 4 has a plate-like shape which corresponds to the adjacent geometry of the pressure vessel 1. The connecting portion 3 of the force application element 2 has an internal thread 8. In FIGS. 5a and 5b it is indicated schematically that the connecting portion 3 has a tapered geometry which is detachably connected to the connecting portion 3, so that the fibers of the fiber-reinforced individual layers are deflected around the connecting portion 3 during the braiding and/or wrapping of the anchoring portion 4. Thereby, the connecting portion 3 is not overbraided or overwrapped. The detachable connection is realized in this case by a screw connection.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are to be regarded as a departure from the disclosure, and all such modifications are intended to be included within the scope of the disclosure.

1. A pressure tank arrangement for storing and discharging compressed fluidic fuels, comprising:
a pressure vessel defining an inner space in which the fuel can be stored, wherein the longitudinal dimension (L) of the pressure vessel is greater than its transverse dimension (Q), whereby the pressure vessel comprises a central portion (M) and at least one end cap (P1, P2) adjacent to the center portion (M), wherein the end cap (P1, P2) is tapering towards an end region (E1, E2);
a reinforcing layer (A) which encloses the center portion (M) and the end cap (P1, P2) of the pressure vessel, wherein the reinforcing layer (A) comprises at least two superposed fiber-reinforced individual layers; and
at least one force application element comprising a connecting portion and an anchoring portion;
wherein
the anchoring portion is disposed between the reinforcing layer (A) and the pressure vessel and/or between the individual layers of the reinforcing layer (A), and wherein the connecting portion penetrates the reinforcing layer (A) and is accessible from outside of the reinforcing layer (A), wherein
the connecting portion protrudes into the space (R1, R2), which is enclosed by
a shell surface (MF) which is obtained by an imaginary extrusion of the outer boundary line (BL) of the largest cross-sectional area of the reinforced central portion (M) in the direction parallel to a centroidal line (S) formed of the centroids (FS) of all cross-sectional areas of the pressure vessel,
a surface (EF1, EF2) intersecting the end region (E1, E2) and extending perpendicular to the centroidal line (S), and
the surface (OF) of the reinforcing layer (A).

2. The pressure tank arrangement according to claim 1, wherein the anchoring portion has a plate-like or disc-like shape.

3. The pressure tank arrangement according to claim 1, wherein the anchoring portion has a shape corresponding to the adjacent outer geometry of the pressure vessel.

4. The pressure tank arrangement according to claim 1, wherein the reinforcing layer (A) is a braided and/or wrapped reinforcing layer (A).

5. The pressure tank arrangement according to claim 1, wherein the pressure vessel has an elongated central portion (M).

6. The pressure tank arrangement according to claim 1, wherein the anchoring portion is disposed between the individual layers of the last third, preferably the last quarter, particularly preferably the last sixth of all individual layers of the reinforcing layer (A), starting from the pressure vessel.

7. The pressure tank arrangement according to claim 1, wherein at least two, preferably at least four force application elements are provided for the or each end cap (P1, P2) and the force application elements are disposed along an imaginary circle of holes, wherein the force application elements have equal distances from each other and/or enclose equal angles relative to each other.

8. The pressure tank arrangement according to claim 1, wherein the anchoring portion or the anchoring portions are fixed in position on the pressure vessel or on an individual layer of the reinforcing layer (A) by an adhesive layer and/or by means of a fixing means.

9. The process for producing a pressure tank arrangement for storing and discharging compressed fluidic fuels, in particular a pressure tank arrangement according to claim 1, comprising:
a pressure vessel defining an inner space in which the fuel can be stored, wherein the longitudinal dimension (L) of the pressure vessel is greater than its transverse dimension (Q), the pressure vessel furthermore comprising a central portion (M) and at least one end cap (P1, P2) adjacent to the center portion (M), wherein the end cap (P1, P2) is tapering towards an end region (E1, E2);
a braided and/or wrapped reinforcing layer (A) which encloses the central portion (M) and the end cap (P1, P2) of the pressure vessel, wherein the reinforcing layer (A) comprises at least two superposed fiber-reinforced individual layers; and
at least one force application element comprising a connecting portion and an anchoring portion,
wherein the anchoring portion is disposed between the reinforcing layer (A) and the pressure vessel and/or between the individual layers of the reinforcing layer (A), and wherein the connecting portion penetrates the reinforcing layer (A) and is accessible from outside of the reinforcing layer (A), and
the connecting portion protrudes into the space (R1, R2), which is enclosed by a shell surface (MF) which is obtained by an imaginary extrusion of the outer boundary line (BL) of the largest cross-sectional area of the reinforced central portion (M) in the direction parallel to a centroidal line (S) formed of the centroids (FS) of all cross-sectional areas of the pressure vessel, by a surface (EF1, EF2) intersecting the end region (E1, E2) and extending perpendicular to the centroidal line (S), and by the surface (OF) of the reinforcing layer (A).

10. The method according to claim 9, wherein the anchoring portion is overbraided and/or overwrapped by at least one individual layer, wherein the connecting portion is at the same time braided and/or wrapped, so that the connecting portion penetrates the reinforcing layer (A) and is accessible or remains accessible from the outside of the reinforcing layer (A), wherein the connecting portion for this purpose comprises a tapering geometry (Z) integrally formed with or detachably connected to the connecting portion, in particular a conical, a cone-shaped or a pyramidal tip, so that the fibers of the fiber-reinforced individual layers are deflected around the connecting portion during the braiding and/or wrapping of the anchoring portion.
